(19) United States
(12) Patent Application Publication
(10) Pub. No.: US 2007/0203261 A1
(43) Pub. Date: Aug. 30, 2007

(54) Reactively blended polyester and filler composite compositions and process

(75) Inventors: Ramani Narayan, Okemos, MI (US); Yogaraj Nabar, Mumbai (IN); Jean-Marie Raquez, Mons (BE); Philippe Dubois, Ciplet (BE)

Correspondence Address: Ian C. McLeod;McLeod & Moyne, P.C., 2190 Commons Parkway, Okemos, MI, 48864, US

(73) Assignee: Board of Trustees of MICHIGAN STATE UNIVERSITY, East Lansing, MI (US)

(21) Appl. No.: 11/362,381

(22) Filed: Feb. 24, 2006

(51) Int. Cl. C08K 9/00

(52) U.S. Cl. 523/205

(57) ABSTRACT

High-performance inorganic filled thermoplastic polyester composites are provided, and the process for preparing thereof. Biodegradable inorganic filled thermoplastic polyester composites are provided by reactive melt-blending of biodegradable thermoplastic polyesters with inorganic fillers using a reactive extrusion processing.

### CROSS-REFERENCE TO RELATED APPLICATIONS

Not Applicable

### STATEMENT REGARDING FEDERALLY SPONSORED RESEARCH OR DEVELOPMENT

Not Applicable

### STATEMENT REGARDING GOVERNMENT RIGHTS

Not Applicable

### BACKGROUND OF THE INVENTION

(1) Field of the Invention

The present invention relates to reactively blended inorganic filled thermoplastic polyester compositions with improved mechanical properties and surface finish, and a process for preparing thereof. Specifically, the present invention relates to biodegradable inorganic filled thermoplastic polyester compositions prepared by reactive melt-blending of thermoplastic polyesters with inorganic fillers, and a process for the preparation thereof. In one (1) specific embodiment, the present invention relates to compositions provided by reactive melt-blending of in situ reactively modified anhydride grafted thermoplastic polyesters with inorganic fillers, optionally using catalytic systems, to promote the interfacial adhesion between anhydride grafted thermoplastic polyesters and inorganic fillers, and thereby to improve the mechanical properties of these inorganic filled thermoplastic polyester compositions.

(2) Description of the Related Art

Aliphatic polyesters such as poly(ε-caprolactone), polylactides and polyhydroxyalkanoates represent the most promising family of biodegradable polymers, whose potential applications cover widely different fields such as packaging for industrial products, mulching films in agriculture, bioresorbable materials for hard tissue replacement and controlled drug delivery devices. With the exception of polyhydroxyalkanoates, high molecular weight aliphatic polyesters such as poly(ε-caprolactone) and polylactides are usually prepared by ring-opening polymerization of their respective cyclic ester. This method provides sufficient polymerization control that results in polymers of the required molecular weights and the desired end-groups. A series of biodegradable aliphatic polyesters have been developed on the basis of the traditional polycondensation reactions. The most notable ones are the poly(alkylene succinate(s) manufactured by Showa Denko, trademarked BIONOLLE® In addition, the strength of biodegradable polyesters derived by polycondensation, may be increased by substituting more rigid aromatic diacids for some alkyl diacid building blocks. Eastman Chemicals and BASF have developed such aliphatic-aromatic copolyesters, so-called EASTAR BIO® and ECOFLEX®, respectively, that retain their biodegradability with a maximum amount of aromatic compounds (terephtalic acid) at about 40 wt % (Gross, R., Science, 297:803-807 (2002)). However, the use of these biodegradable thermoplastic (co)polyesters as bulk materials is still restricted by their relatively high cost, and poor mechanical properties compared to commodity plastics such as polyethylene and polypropylene. Combination of these biodegradable polymers with cheap inorganic fillers such as talc provides a useful way for reducing the cost, and for optimizing the properties of biodegradable thermoplastic polyesters as well (Hu, G., Polym. Eng. Sci., 36: 676-684 (1996), U.S. Pat. No 6,495,656 and U.S. Pat. No 4,795,801). Developing a melt-blend with satisfactory overall physico-mechanical behavior will depend on the ability to control interfacial tension to generate a small-dispersed phase size and strong interfacial adhesion. It is of prime importance to achieve high-performance mechanical properties for the final material. Accordingly, functionalization of the filler surface or polymer matrix is used for reducing the interfacial tension, strengthening the interfacial adhesion and minimizing the coalescence (Tserki, V., J. Applied Polym. Sci. 88:1825-1835 (2003)).

Since not all polymers contain functional group(s), free radical grafting of unsaturated polar compounds bearing the desired functional group(s) is usually employed for functionalization. Typically, functional groups such as isocyanate, amine, anhydride, carboxylic acid, epoxide and oxazoline are introduced through a fast reactive extrusion process, and then combined with their respective suitable reactive functions, such as hydroxyl-isocyanate, amine-anhydride, amine-epoxide, amine-lactam, amine-carboxylic acid and amine-oxazoline (Smith M., March, J., March's Advanced Organic Chemistry , Wiley-Interscience, Ed. 5^{th}, New York, 2001, pp.389-1506), promoted eventually by Lewis Acid/Base catalyses. Two reactive melt-blending processes can be thus envisioned: (i) the polymer is functionalized, and the functionalized polymer is then reactively melt-blended with the filler as a two-step reactive extrusion process; (ii) both the functionalization and reactive blending steps are executed in the same reactive extrusion process. Processes are called (i) in situ compatibilization of polymer-filler composite by two-step reactive extrusion process; and (ii) one-step reactive extrusion process. To some extent, the one-step reactive extrusion process is highly desirable for more economic concerns in contrast to the two-step one (Hu, G., Polym. Eng. Sci., 36: 676-684 (1996), U.S. Pat. No 5,114,658).

Reactive extrusion is an attractive route for polymer processing in order to carry out melt-blending, and various reactions including polymerization, grafting, branching and functionalization as well (Mani, R. et al., J. Polym. Sci.: Part A: Polym. Chem., 37: 1693-1702 (1999), Michaeli, W. et al., J. Appl. Polymer Sci. 48:871-886 (1993); Kye, H., et al., J. of Appl. Polymer Sci. 52:1249-1262 (1994), U.S. Pat. No. 5,412,005, Carlson, D. et al., J. Appl. Polymer Sci., 72:477-485 (1999), U.S. Pat. No 6,114,076, U.S. Pat. No 6,579,934 and U.S. Pat. No. 5,906,783). Free radical chemical reaction through reactive extrusion has extensively been done on polypropylene and polyethylene backbones, leading to controlled degradation and branching (U.S. Pat. No 4,857,600 and U.S. Pat. No 5,346,963). In addition, the economics of using the extruder for conducting chemical modifications has shown that the extrusion technique efficiently affords low cost production and processing, which enhances the commercial viability and cost-competitiveness of these materials. Reactive extrusion represents an effective way for performing the reactive modification of biodegradable thermoplastic polyesters, and the reactive melt-blending of the in situ reactively modified biodegradable thermoplastic polyesters with inorganic fillers through one-step process.

### OBJECTS

It is therefore an object of the invention to provide novel biodegradable inorganic filled thermoplastic polyester compositions derived by reactive melt-blending of biodegradable thermoplastic polyesters with inorganic fillers. It is another object of the invention to provide a novel reactive extrusion process for preparing the biodegradable inorganic filled thermoplastic polyester compositions at high throughput. Specifically, it is an object of the invention to provide a continuous one-step reactive extrusion processing for preparation of the biodegradable inorganic filled thermoplastic polyester composites. It is further an object of the present invention of biodegradable thermoplastic polyester compositions having excellent surface finish, and improved mechanical properties.

These and other objects will become increasingly apparent by reference to the following description and drawings.

### SUMMARY OF THE INVENTION

The present invention relates to compositions that are derived using a reactive extrusion process, by (i) free radical grafting unsaturated anhydride compounds bearing polar group(s) such as maleic anhydride, onto biodegradable thermoplastic polyesters to serve as adhesion promoters, and by (ii) chemically bonding these grafted biodegradable thermoplastic polyesters to inorganic fillers, to promote the interfacial adhesion of biodegradable thermoplastic polyesters and inorganic fillers, and thereby to form thermoplastic polyester compositions having improved mechanical properties therefrom. Optionally, catalytic systems can be used to promote the chemical bonding of the anhydride grafted thermoplastic polyesters to inorganic fillers.

Specifically, it is an object of the invention to provide compositions that are derived by (i) free radical grafting of unsaturated compounds bearing polar group(s) such as maleic anhydride, onto biodegradable thermoplastic polyesters, and by (ii) chemically or physically bonding these grafted biodegradable thermoplastic polyesters to inorganic fillers, to promote the interfacial adhesion of biodegradable thermoplastic polyesters and inorganic fillers, and thereby to improve the mechanical properties of biodegradable inorganic filled thermoplastic polyesters therefrom. Specifically, inorganic fillers shall refer to inorganic fillers bearing functional groups, naturally present or derived during the process, which are capable of physically or chemically bonding to the polar group(s) derived from the in situ reactively modified biodegradable thermoplastic polyesters. Optionally, Lewis base/acid catalyses such as tin(II) octoate may be used to promote the chemical bonding of the grafted biodegradable thermoplastic polyesters to inorganic fillers.

Specifically, the present invention relates to compositions containing biodegradable inorganic filled thermoplastic polyester composites derived by reactive melt-blending of biodegradable thermoplastic polyesters with inorganic fillers, which are useful in making biodegradable articles.

The present invention relates to a composite compositions which comprises: (a) a reactively blended polyester polymer which has been reactively blended with an organic anhydride to provide an anhydride modified polymer; and (b) an inorganic filler having hard surface exposed hydroxyl groups which were also reacted with the anhydride modified polymer, the filler being present in an amount between about 15 and 40% by weight of the composition. Further, the invention relates to a composition wherein the reactively blended polymer of (a) has been produced before having been reactively blended with the filler of (b). Preferably the composition wherein the reactively blended polymer of (a) has been produced simultaneously with the reactively blended filler of (b). Most preferably, the polyester is poly(butylene adipate co-terephtalate). The composition where the anhydride is maleic anhydride. Further, the composition where the polyester is poly (butylenes adipate co-terephtalate) and the anhydride is maleic anhydride. Preferably wherein the composition has been further reacted with a Lewis acid or Lewis base which produced an increased molecular weight of the anhydride modified polymer. The composition which has been reacted with a free radical initiator for the reaction of the organic anhydride with the polyester polymer. The composition wherein the filler is talc.

Further, the present invention relates to a reactively blended composition which comprises: an organic anhydride modified polyester polymer; (b) an inorganic filler having exposed surface hydroxyl groups reacted with the anhydride modified polyester polymer, the filler being present in an amount between about 15 and 40% by weight of the composition; and (c) a Lewis acid or Lewis base which produces an increased molecular weight of the anhydride modified polyester polymer, in an amount of less than about 5% by weight of the composition. Preferably the invention relates to a free radical initiator for the reaction of the organic anhydride with the polyester polymer. Most preferably wherein the polyester polymer is biodegradable. The composition wherein the polyester is poly(butylenes adipate co-terephtalate) The composition wherein the anhydride is maleic anhydride. The composition wherein the polyester is poly(butylene adipate co-terephtalate and the anhydride is maleic anhydride. The composition wherein the Lewis acid is tin octonate. The composition where the free radical initiator is 2,5-dimethyl-2,5-di-(tert-butylperoxyhexane). The composition where the filler is talc.

Still further, the present invention relates to a composite composition which comprises: (a) a reactively blended polyester polymer covalently bonded to an unsaturated compound as a result of having been blended; and (b) an organic filler having hard surface groups which react with the polymer of (a) which reacted with the coupled unsaturated compound, the filler being present in an amount between about 15 and 40% by weight of the composition.

Thus, the invention relates to biodegradable inorganic filled thermoplastic polyester compositions with improved mechanical properties and excellent surface finish, and the process for preparing using a reactive blended process. Specifically, the present invention relates to biodegradable inorganic filled thermoplastic polyester compositions derived by reactive melt-blending of biodegradable thermoplastic polyester with an inorganic filler, using a reactive process. More specifically, the present invention relates to biodegradable thermoplastic polyester compositions derived by a continuous one-step reactive process for (i) reactively modifying biodegradable thermoplastic polyesters, and (ii) chemical or physical bonding the resulting reactively modified biodegradable thermoplastic polyesters to fillers, optionally using catalytic systems.

More specifically,

(i) the present invention relates to reactive extrusion steps for in situ reactively modifying biodegradable thermoplastic polyesters. Specifically, the present invention relates to a reactive process for in situ grafting unsaturated compounds bearing polar group(s) onto the biodegradable thermoplastic polyesters through a free radical process, to promote the interfacial adhesion between the in situ modified biodegradable thermoplastic polyesters therefrom, and inorganic fillers; and

(ii) to a reactive extrusion step for chemically or physically bonding the in situ reactively modified biodegradable thermoplastic polyesters to inorganic fillers, through the unsaturated anhydride compounds bearing polar group(s) grafted onto the biodegradable thermoplastic polyester backbone derived by the aforementioned process (i), and the suitable functional groups bore by the inorganic fillers, naturally present or derived. The invention optionally uses catalytic systems including Lewis acid or base such as organometallics, inorganic and organic compounds for promoting the formation of chemical bonds between the functional groups derived from the inorganic fillers, and the reactively modified thermoplastic polyesters.

The present invention further relates to biodegradable thermoplastic polyester composites derived from the aforementioned continuous one-step process, having better mechanical properties and excellent surface finish compared to the ones derived from the simple and/or two-step reactive extrusion process melt-blending of biodegradable thermoplastic polyesters with inorganic fillers. As used herein, the two-step reactive extrusion process shall refer to the two distinctive steps for (i) in situ reactively modifying biodegradable thermoplastic polyesters, and for (ii) chemically or physically bonding the resulting reactively modified biodegradable thermoplastic polyesters to inorganic fillers, optionally using catalytic systems. Finally, the present invention relates to compositions derived from the inorganic filler and thermoplastic polyesters, which are useful in making biodegradable articles, and having better mechanical properties and excellent surface finish. The present invention also relates to compositions derived from the biodegradable inorganic filled thermoplastic polyester compositions, optionally melt-blended with secondary components that are useful in making polymers, resins, specifically biodegradable articles, and more specifically biodegradable films. These biodegradable inorganic filled thermoplastic polyester compositions can be used as is or be subsequently admixed with other components like stabilizers, fillers, additives and other polymers. Specifically, the present invention relates to biodegradable compositions derived from the biodegradable inorganic filled thermoplastic polyester composites with other components like fillers, plasticizers, additives and other polymers, wherein these are preferably selected from the group consisting of starch, modified or not, copolymer of maleic anhydride, poly(butylene succinate), poly(butylene succinate-co-terephtalate) and polycaprolactone, ethylene-vinyl acetate copolymer, poly(vinyl alcohol), ethylene vinyl alcohol copolymer, polylactide, organic peroxide, and a mixture of peroxide and maleic anhydride.

### BRIEF DESCRIPTION OF THE DRAWINGS

FIG. 1 is a twin-screw extruder used for reactively melt-blending in situ reactively modified biodegradable thermoplastic polyesters with inorganic fillers.

FIG. 2 is a screw configuration used for reactively melt-blending in situ reactively modified biodegradable thermoplastic polyesters with inorganic fillers.

FIG. 3 are SEM images of the sample A prepared by simple melt-blending.

FIG. 4 are SEM images of the sample D prepared by the two-step reactive extrusion process in the presence of catalyst.

FIG. 5 are SEM images of the sample D prepared by the one-step reactive extrusion process in the presence of catalyst.

### BRIEF DESCRIPTION OF THE PREFERRED EMBODIMENTS

The present invention relates to biodegradable inorganic filled thermoplastic polyester compositions in which the biodegradable thermoplastic polyesters are reactively modified for physically or chemically bonding to inorganic fillers, wherein the biodegradable inorganic filled thermoplastic polyester composites formed of the above composite product have improved mechanical properties and excellent surface finish. It is further preferred that, compositions derived by reactive melt-blending of in situ reactively modified biodegradable thermoplastic polyesters with inorganic fillers, have better mechanical properties and excellent surface finish compared to the ones derived from the simple melt-blending of biodegradable thermoplastics with inorganic fillers. The present invention preferably concerns such improvements without undesirably affecting other preferred characteristics of the biodegradable thermoplastic polyesters including, for instance: biodegradability and thermal properties. The biodegradable inorganic filled thermoplastic polyester composites based on the above reactive melt-blending can be easily formed according to a process of the present invention to be described later.

The components that are employed in the process that is within the scope of this invention include the following:
(I) Biodegradable thermoplastic polyesters selected from the group of poly(butylene succinate-co-butylene adipate) copolymer, poly(butylene succinate-co-terephtalate) copolymer, poly(butylene adipate-co-terephtalate) copolymer, poly(ε-caprolactone), polylactides, poly(hydroxyalkanoate), and the like;
(II) Inorganic filler bearing suitable functional groups, particularly hydroxyl groups naturally present or derived during the process, selected from the group of talc, silicate and metal hydroxides, mica and the like;

The choice of preferred biodegradable thermoplastic polyester, as outlined in (I) above, is based on biodegradability, compatibility considerations, molecular weight, melt viscosity, mechanical and thermal properties, processability, hydrophobicity and cost. The more important amongst these are believed to be biodegradability, processability, mechanical and thermal properties, compatibility, and cost considerations.

The biodegradable thermoplastic polyesters useful in the present invention that are not especially limited in kind, include polymers, a mixture of polymers, or a copolymer of such polymers prepared by
(i) the condensation polymerization of a polybasic acid (or its ester) with a glycol an acid anhydride thereof, and/or;
(ii) the condensation polymerization of hydroxylcarboxylic acid, and/or;
(iii) the ring-opening (co)polymerization of a cyclic acid anhydride with a cyclic ether, and/or;
(iv) the ring-opening (co)polymerization of cyclic ester; and
(v) the microbial pathway of polyhydroxyalkanoate(s).

Ring-opening polymerization catalysts by methods such as polymerization in solvents and in bulk (absence of any solvent). Enzymatic catalyses may be used to promote the ring-opening polymerization. Microbial pathway may used to prepare poly(hydroxyalkanoate)s. Biodegradable thermoplastic polyesters may be linear polymers, long-chain/short-chain branched polymers, block/random polymers, dendrimers, and the mixtures thereof. A long-chain/short-chain branched aliphatic polyester or dendrimer is generally prepared by using an additional polyfunctional component selected from the group consisting of trifunctional or tetrafunctional polyols, oxycarboxylic acids, and polybasic carboxylic acids.

Examples of the polybasic acid, as used in the above process (i), include succinic acid, adipic acid, suberic acid, terephtalic acid, isophthalic acid, 2,6-naphthalenedicarboxylic acid, 1,4-naphthalenedicarboxylic acid, diphenyldicarboxylic acid, diphenoxyethanedicarboxylic acid, diphenylsulfonedicarboxylic acid, diphenyl ether dicarboxylic acidsebacic acid, azelaic acid, decanedicarboxylic acid, octadecanedicarboxylic acid, dimer acid, their esters, and the like. Examples of the glycol include ethylene glycol, propylene glycol, 1,3-propanediol, 1,4-butanediol, neopentyl glycol, 1,5-pentanediol, 1,6-hexanediol, and decamethylene glycol. In addition, it is also possible to use polyoxyalkylene glycol as a part of the glycol component. Examples of this polyoxyalkylene glycol include polyoxyethylene glycol, polyoxypropylene glycol, polyoxytetramethylene glycol, and their copolymers.

Examples of the hydroxycarboxylic acid, as used in the above process (ii), include glycolic acid, lactic acid, 3-hydoxypropionic acid, 3-hydroxy-2,2-dimethylpropionic acid, 3-hydroxy-3-methyl-butyric acid, 4-hydroxybutyric acid, 5-hydroxyvaleric acid, 3-hydroxybutyric acid, 3-hydroxyvaleric acid, 4-hydroxyvaleric acid, 6-hydroxycaproic acid, citric acid, maleic acid, and their esters.

Examples of the cyclic acid anhydride, substituted or not, as used in the above process (iii), include succinic anhydride, maleic anhydride, itaconic anhydride, glutaric anhydride, adipic anhydride, and citraconic anhydride. Examples of the cyclic ether, substituted or not, include ethylene oxide, propylene oxide, cyclohexene oxide, styrene oxide, epichlorohydrin, allyl glycidyl ether, phenyl glycidyl ether, tetrahydrofuran, oxepane, and 1,3-dioxolane. Examples of the cyclic ester, substituted or not, as used in the above process (iv), include. beta.-propiolactone, .beta.-methyl-.beta.-propiolactone, .delta.-valerolactone, .epsilon.-caprolactone, glycolide, 1,4-dioxan-2-one, and lactide. Examples of polyhydroxyalkanoates, substituted or not, as used in the above process (v), include poly(3-hydroxybutyrate) and poly(3-hydroxybutyrate-co-3-hydroxyvalerate) copolymer.

Biodegradable thermoplastic polyesters may be prepared by transesterification reactions from aliphatic polyesters and aromatic (co)polyesters via methods using transesterification catalysts or not. Biodegradable thermoplastic polyesters may be combined with chain-extending agents including isocyanates, epoxides, aziridines, oxazolines, multivalent metal compounds, multifunctional acid anhydrides, phosphate esters, and phosphite esters. These can be used either alone respectively or in combination with each other.

The preferred biodegradable thermoplastic polyesters within the scope of the invention are polybutylene adipate co-terephtalate, polylactide, poly(alkylene succinate), and polycaprolactone (co)polymers, and more preferably polybutylene adipate co-terephtalate and polycaprolactone (co)polymers. It is further preferred that the preferred biodegradable thermoplastic polyesters be, ranging between 10 and 99% by weight, preferably, ranging between 20 and 80% of the total amount of biodegradable inorganic filled thermoplastic polyester composites.

Coupling, compatibilizing or mixing agents can be added to the biodegradable thermoplastic polyesters, as outlined in (i), to promote the interfacial adhesion thereof with the inorganic fillers, as outlined in (ii). Preferably, biodegradable thermoplastic polyesters are modified by free radical grafting of unsaturated compounds including polar monomers such as maleic anhydride or esters, acrylic or methacrylic acid or esters, vinylacetate, acrylonitrile, and styrene. Virtually any olefinically reactive residue that can provide a reactive functional group on modified biodegradable thermoplastic polyesters can be useful in the invention.

Unsaturated compounds bearing polar group(s), and the mixtures thereof, that is preferred within the scope of the invention, contains at least one ethylenic unsaturation, e.g. at least one double bond, and at least one polar group such as hydroxyl, epoxide, isocyanate, carboxyl, haloglycidyl, cyano, amino, carbonyl, thiol, sulfonic, sulfonate and the like, which will free radically graft onto the biodegradable thermoplastic polyesters. The preferred unsaturated compounds bearing polar group(s) useful for the invention are compounds that contain at least one ethylenic unsaturation, and at least one carbonyl group, which are the carboxylic acids, anhydrides, esters, and their salts, both metallic and non-metallic. It is most preferred that the unsaturated compounds bearing polar group(s) containing at least one ethylenic unsaturation, and at least one carbonyl group, be maleic, fumaric, acrylic, methacrylic, itaconic, crotonic, alpha-methyl crotonic and cinnamic acid, and their anhydride, ester and salt derivatives, if any, and the mixtures thereof, and more preferably maleic anhydride. It is preferred that the content of unsaturated compounds bearing polar group(s) containing at least one ethylenic saturation, and at least one polar group be at least about 0.3 wt %, and preferably at least about 0.8 wt % based on the combined weight of the polymer and the organic compounds. The maximum amount of unsaturated compounds bearing polar group(s) can vary to convenience, but typically it does not exceed about 20 wt %, preferably about 10 wt %, and more preferably about 5 wt %. An excess of unsaturated compounds bearing polar group(s) such as maleic anhydride has a deleterious effect on the molecular weight of the in situ reactively modified biodegradable thermoplastic polyesters, which leads to poor mechanical and thermal properties for the in situ reactively modified biodegradable thermoplastic polyesters, and the resulting reactive melt-blending of the in situ reactively modified biodegradable thermoplastic polyesters with inorganic fillers (Mani, R. et al., J. Polym. Sci.: Part A: Polym. Chem., 37: 1693-1702 (1999)). For example, during the free radical grafting of polyester chains with maleic anhydride, chain scissions can occur through scissions, which leads to the formation of a vinyldene chain end and a radical chain decreasing the resulting molecular weight.

The unsaturated compounds bearing polar group(s) can be grafted onto biodegradable thermoplastic polyesters by any known technique suitable for generating free radicals, which comprises microwave, sonification, a temperature raising, or free radical initiators; and more preferably, by using free radical initiators, and the mixtures thereof. Within the scope of the invention, it is preferred that the free radical initiator be an organic peroxide such as 2,5-dimethyl-2,5-bis(tert-butylperoxy)hexane, tert-butylperoctoate, tert-butylperoxypivalate, dicumylperoxide, 1,1-bis(tert-butylperoxy)-3,3,5-trimethylcyclohexane, bis(tert-butylperoxy-isopropyl)benzene and the like. Azo compounds, such as azobisisobutyronitrile may also be used. It is further preferred that the amount of free radical initiators be sufficient to initiate the grafting reaction of unsaturated compounds bearing polar group(s) onto biodegradable thermoplastic polyesters. In particular, it is preferred that the grafting efficiency of the free radical initiator reaches an optimum radical concentration, which depends on the molar ratio of free radical initiator-to-unsaturated polar compounds bearing polar group(s). The free radical initiator content is very important in order to prepare satisfactory mechanically improved melt-blending of in situ reactively modified biodegradable thermoplastic polyesters with inorganic fillers. For example, the use of free radical initiators can be beneficial to enhance the molecular weight, and therefore the melt-strength and mechanical properties of biodegradable thermoplastic polyesters through intermolecular branching and cross-linking. However, if the amount of free radical initiator is too high, it will create too highly cross-linked biodegradable thermoplastic polyesters, which then can not be processed into films, fibers or other useful products. In accordance with the scope of the invention, it is preferred that the organic peroxide catalysts be ranging from 0.01 to 10 weight percent, and more preferably from 0.03 to 2 weight percent of the combined amount of biodegradable thermoplastic polyesters and free radical initiator.

The choice of the inorganic filler, as outlined in (ii) above, which is to be chemically or physically bound to the in situ reactively modified biodegradable thermoplastic polyesters, is based on particle size, particle shape, particle functionality, and cost, and more preferably the particle size, particle shape and particle functionality. As used herein, the term particle functionality is referred to chemical functions bore by inorganic fillers, which are capable of physically or chemically bonding to the polar group(s) derived from the in situ reactively modified biodegradable thermoplastic polyesters. Specifically, it is preferred that the suitable functions bore by inorganic fillers be capable of forming, at least strong interactions, preferably hydrogen bonding, Electron Donor-Acceptor bonding, ionic bonding and covalent bonding, and more preferably ionic bonding and covalent bonding to the polar group(s) derived from the in situ reactively modified biodegradable thermoplastic polyesters. Suitable functions bore by inorganic fillers, which are to be involved for physically or chemically bonding to the polar group(s) derived from the in situ reactively modified biodegradable thermoplastic polyesters, also refer to the ones derived from surface treatment of inorganic fillers such as oxidation, plasma treatment, electrical discharge, chemical treatment, burning and adsorption, and the like. It is further referred to suitable functions bore by inorganic fillers, which may be derived from the ongoing process for reactively melt-blending in situ reactively modified biodegradable thermoplastic polyesters with inorganic fillers. For example, free radical initiators are capable of free radically attacking the surface of the talc yielding the formation of new silanol groups onto the talc surface (U.S. Pat. Nos. 6,706,320; 5,229,094 and Silva, C. et al., Chem. Mater., 14:175-179 (2002)). The most preferred functional groups bore by inorganic fillers are hydroxyl, carboxyl, haloglycidyl, cyano, amino, carbonyl, thiol, sulfonic, sulfonate and the like, that are useful to be chemically or physically bound to the polar group(s) derived from the in situ reactively modified biodegradable thermoplastic polyesters such as isocyanate, hydroxyl, anhydride, epoxide, lactam, and oxazoline, and the like.

Within the scope of the invention, it is also preferred that inorganic fillers are in a form of individual, discreet particles including inorganic fillers having higher aspect ratios such as talc, mica, and wollastonite. It is further preferred that inorganic fillers can improve toughness, softness, opacity, vapor transport rate, water dispersibility, biodegradability, fluid immobilization and absorption, skin wellness, and other beneficial attributes of the film. It is preferred that the inorganic filler is, at least one material selected from the group consisting of metal oxides, metal hydroxides, metal carbonates, metal sulfates, various kinds of clay, alumina, powdered metals, glass microspheres, vugular void-containing particles, silicate, or talc. It is most preferred that the inorganic filler be talc, mica, wollastonite, calcium carbonate, barium sulfate, sodium carbonate, magnesium carbonate, magnesium sulfate, barium carbonate, kaolin, carbon nanotube, calcium oxide, magnesium oxide, aluminum hydroxide, and titanium dioxide, and more preferably, talc and aluminum hydroxide.

The amount of unsaturated compounds bearing polar group(s) to be grafted onto the in situ reactively modified biodegradable thermoplastic polyesters will, of course, vary with the nature and amount of inorganic fillers bearing polar group(s), the functionality of fillers, the physical and chemical characteristics of the substantially biodegradable thermoplastic polyesters and unsaturated compounds bearing polar group(s), and similar factors. Typically, the weight ratio of in situ reactively modified biodegradable thermoplastic polyesters to inorganic fillers is between 5:95 and 95:5, preferably between 20:80 and 80:20, and more preferably between 70:30 and 30:70.

Optionally, a variety of catalytic systems, and the mixtures thereof, may be useful for chemically bonding the in situ reactively modified biodegradable thermoplastic polyesters to the inorganic fillers. Generally, it is preferred to employ catalytic systems in order to enhance the reaction rate for chemically bonding the in situ reactively modified biodegradable thermoplastic polyesters to the inorganic fillers. It is further preferred to employ a catalyst in order to improve the grafting efficiency for chemically bonding the in situ reactively modified biodegradable thermoplastic polyesters to the inorganic fillers. Applicants have observed that the most preferred maleic anhydride grafted onto the biodegradable thermoplastic polyesters efficiently react (through ring-opening reactions), using tin octoate as catalyst, with hydroxyl groups from the edge surface of talc, to form ester linkages. Chemical bonding contributes to the improved mechanical properties of the biodegradable inorganic filled thermoplastic polyester composites derived from the aforementioned process by maximizing the interfacial adhesion between the biodegradable thermoplastic polyesters and inorganic filler.

Two (2) classes of catalytic systems are preferred, but not limited, to carry out the reactive process for chemically bonding in situ reactively modified biodegradable thermoplastic polyesters to the inorganic fillers, as outlined in (i) and (ii) above; one being Lewis acid catalysts such as Ti, Zn, and Sn salts and the like, more preferably stannous octoate (stannous 2-ethyl hexanoate), and the second being Lewis base like pyridine, 4-dimethylaminopyridine, triphenylphosphine, trimesitylphosphine, and the like, more preferably, 4-dimethylaminopyridine. It is preferred that the amount of such catalysts be less than 5 wt %, and preferably less than 2 wt %, and more preferably less than 1 wt % by weight of the combined weight of biodegradable thermoplastic polyesters and the catalytic system. It has been found that a higher amount of catalyst with respect to biodegradable thermoplastic polyesters has a deleterious effect on the molecular weight of the in situ reactively modified biodegradable thermoplastic polyesters. Such catalysts can promote the intramolecular and/or intermolecular transesterification reactions of biodegradable thermoplastic polyesters, which leads to the formation of low molecular weight oligomers, and therefore to low melt-strength, poor mechanical properties for the in situ reactively modified biodegradable thermoplastic polyesters, and the resulting reactive melt-blending of the in situ reactively modified biodegradable thermoplastic polyesters with inorganic fillers as well.

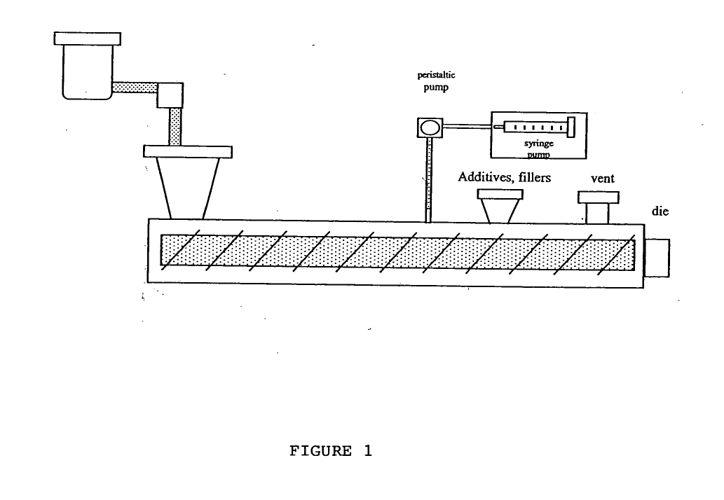

In another embodiment, there is provided a process for preparing the biodegradable inorganic filled thermoplastic polyester compositions. Specifically, it is preferred that biodegradable inorganic filled thermoplastic polyester compositions are derived by reactive melt-blending of in situ reactively modified biodegradable thermoplastic polyesters with inorganic fillers at high throughput. More preferably, a reactive extrusion processing is used to manufacture the biodegradable thermoplastic polyester composites at high throughput. It is further preferred that the biodegradable inorganic filled thermoplastic polyester composites are derived at high throughput through a continuous one-step reactive extrusion process. More preferably, a continuous one-step process for (i) free radical grafting of unsaturated compounds bearing polar group(s) onto the biodegradable thermoplastic polyester, and (ii) chemically or physically bonding the in situ grafted biodegradable thermoplastic polyester to inorganic fillers, can be used for preparation of biodegradable thermoplastic polyester composites at high throughput and low-cost production, wherein the chemical modification is conducted in the absence of solvent, and an extruder or similar equipment is used for the chemical modification; and optionally wherein the catalytic system is previously admixed with the biodegradable thermoplastic polyesters or added downstream in the extruder. A schematic of the extruder apparatus is illustrated in FIG. 1. This schematic is merely exemplary and is not to be construed as a limitation, since any kind of the extruder can be used in this invention. Biodegradable thermoplastic polyester (component I), free radical initiator (component II), unsaturated compounds bearing polar group(s) (component III), and inorganic fillers (component IV) were previously mixed together, and were then introduced into the feed throat of a twin-screw extruder (such as a Century ZSK-30 co-rotating twin screw extruder) at a feed rate of 500-9000 g/hr by means of a solid metering. Alternatively, biodegradable thermoplastic polyester (component I), free radical initiator (component II), unsaturated compounds bearing polar group(s) (component III), and inorganic fillers (component IV) can be separately introduced; in the case of liquid component by means of a peristaltic pump, and in the case of solid component by means of a solid metering device at a feed rate of 40-8000 g/hr. Biodegradable thermoplastic polyester and inorganic fillers can be dried before extrusion. The presence of some trace of water has a deleterious effect on the molecular weight of some biodegradable thermoplastic polyester such as polylactide, and thereby the melt-strength thereof. The extruder screw speed was 20-300 rpm, preferably 30-150 rpm, and the extrusion temperature was between 80° C. and 250° C., preferably between 150 and 190° C. For promoting the chemical or physical grafting reactions of biodegradable thermoplastic polyesters onto the inorganic fillers, the catalytic system (component V) is optionally added downstream (away from the feed throat) or admixed with one of components (I-IV), or the mixture of biodegradable thermoplastic polyester (component I), free radical initiator (component II), unsaturated compounds bearing polar group(s) (component III), and inorganic fillers (component IV), and/or introduced as separate streams in the feed throat. The catalytic system (component V) is introduced in the case of liquid by means of a peristaltic pump or in the case of solid by means of a solid metering at a feed rate of 4-450 g/hr. Alternatively, the catalytic system (component V) may be solubilized in inert solvent to lower the level of addition, as a proportion of the overall reaction composition. Examples of inert solvent include dimethoxybenzene, N,N-dimethylformamide, acetone, toluene, tetrahydrofuran, and the like. Downstream from the feed throat, other feed sections may be provided for optional additives like plasticizers, fillers, reaction terminators or other additives. The extruder may be fit with at least one pressure vent and at least one vacuum vent. These vents allow removal of volatiles such as solvents or unreacted products. A die was used to extrude the polymer product.

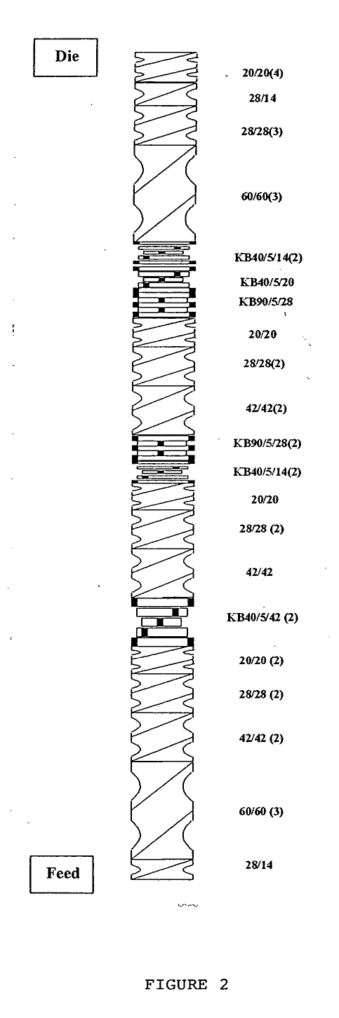

The extruder is operated with a screw design and size, barrel diameter and length, die configuration and open cross-section, barrel temperature, die temperature, screw speed, pre-extrusion and post-extrusion conditions, and reactant addition ports designed to provide the appropriate residence times and reaction temperatures (i) for in situ reactively modifying biodegradable thermoplastic polyesters, and (ii) for chemically or physically bonding the in situ reactively modified biodegradable thermoplastic polyesters to inorganic fillers. The variance of one factor may require adjustment of one or more of the other factors. These factors, however, are readily optimized by one of ordinary skill in the art without undue experimentation. Specifically, it is preferred that the extruder conditions are set to carry out the reactive melt-blending of in situ reactively modified biodegradable thermoplastic polyesters with inorganic fillers at least at 100° C., preferably with residence times up to 12 minutes for ensuring a cost-effective process. The extruder may be operated continuously, and thus the components are ideally introduced into the extruder at a steady rate over an extended period. It is further preferred that screw configurations in the extruder are designed to provide the necessary feed and melt conveying, melting and mixing, and pumping to suit the process and residence time. Preferably, the screw configuration will be built up of both kneading blocks for ensuring thorough mixing and homogenization, and conveying blocks for conveying the plug flow. FIG. 2 shows the screw configuration for reactively melt-blending in situ reactively modified biodegradable thermoplastic polyesters with inorganic fillers that were employed, which ensures enough mixing, homogenization, and conveying. It is further preferred that the extrusion machine will be a closely intermeshing co-rotating twin-screw extrusion machine. This enables a high number of exchange processes, and at the same time a versatile build-up of conveying and mixing elements with an adequate thermal/mechanical input. A further advantage is that a twin-screw extrusion machine made of screws and cylinder parts is modularly built-up ensuring the greatest possible flexibility to optimally adapt the specific conditions for reactively melt-blending in situ reactively modified biodegradable thermoplastic polyesters with inorganic fillers. The extruder may be maintained under essentially aerobic conditions or may be maintained under anaerobic conditions by purging or blanketing with an inert gas such as nitrogen, carbon dioxide, helium or argon.

The process scheme outlined above is used to derive compositions; especially biodegradable compositions like pellets, films, sheets, molding, foams, and fibers starting from the reactive melt-blending of in situ reactively modified biodegradable thermoplastic polyesters with inorganic fillers. It is further preferred that compositions derived from the aforementioned one-step reactive extrusion process have better mechanical properties and excellent surface finish compared to the ones derived from the simple and/or two-step reactive extrusion process melt-blending of biodegradable thermoplastic polyesters with inorganic fillers. The two-step reactive extrusion process refers to a process for distinctively performing (i) the reactive modification of biodegradable thermoplastic polyesters, and then (ii) the reactive melt-blending of the reactively modified biodegradable thermoplastic polyesters with inorganic fillers in an extruder. Such a two-step reactive extrusion process involves reprocessing the reactively modified biodegradable thermoplastic polyesters, which leads to further thermal degradation, lowering the molecular weights and, hence, the mechanical properties for the resulting biodegradable inorganic filled thermoplastic polyesters as-obtained after the reactive melt-blending of reactively modified biodegradable thermoplastic polyesters with inorganic fillers. The two-step reactive extrusion process is also time-consuming and cost-ineffective compared to the one-step one.

Blends of mechanically improved compositions derived from the aforementioned one-step reactive extrusion process, with other polymers, plasticizers, stabilizers and fillers are also included within the scope of this invention. Such a blend composition using the aforementioned one-step reactive extrusion process for chemically or physically bonding in situ reactively biodegradable thermoplastic polyesters to inorganic fillers comprises one or more of the following:
(A) Optionally, other polymers, including those derived from the condensation polymerization of a polybasic acid (or its ester) with a glycol and an acid anhydride, the condensation polymerization of hydroxylcarboxylic acid, the ring-opening (co)polymerization of a cyclic acid anhydride with a cyclic ether, the ring-opening (co)polymerization of cyclic ester, polyorthoesters, polymers and copolymers of hydroxybutyrate and hydroxyvalerate, poly(alkylene d-tartrate), vinyl polymers like poly(vinyl alcohol), poly(vinyl acetate), ethylene vinyl alcohol copolymer, ethylene-vinyl acetate copolymer, polyanhyrides like polyadipic anhydride, polycarbonates, proteins, polysaccharides like starches and cellulosics including cellulose, cellulose acetate, cellulose butyrate, and cellulose propionate, lignocellulose, starch, starch esters and amylose esters, each of these being in a form that is granular, plasticized, destructurized, solvated or physically or chemically modified in any other way, copolyester amides, preferably based on caprolactone and caprolactam, polyolefins, polyurethanes, and mixtures thereof, each of these being hydrophobic or not, modified or not as in branched, cross-linked, copolymerized, functionalized, surface-modified, physically or chemically modified in other similar ways. The branching or cross-linking is conducted separately or in situ by a peroxide initiation; copolymers includes copolymers of lactones, lactides, and glycolide, substituted or not with each other and graft copolymers of lactones, lactides, and glycolide, substituted or not with various functional monomers like maleic anhydride, stearic anhydride, ethylene oxide, aliphatic and aromatic isocyanates, and acrylic acid, wherein the grafting of these functional monomers is conducted separately or in situ, preferably by peroxide initiated grafting in an extruder, and wherein the amount of grafted monomer is at least 0.1% with respect to the main polymer; functionalization of lactones, lactides, and glycolide, substituted or not related to end-capping these polymers with suitable functional groups like unsaturated groups, isocyanate groups and the like. Of these, the preferred polymers are those that are biodegradable, such as those based on proteins, polysaccharides as described above, polymers of lactones, lactides, and glycolide, substituted or not, aliphatic polyesters, aliphatic-aromatic copolyesters, polyamides and polyester amides, and mixture thereof, each of these being hydrophobic or not, modified or not as in branched, cross-linked, copolymerized, functionalized, surface-modified, physically or chemically modified in other similar ways. The preferred amount of these polymers in the final composition is in the range of 10 to 90% by weight, and
(B) Optionally, peroxides to cross-link the polyester and improve melt strength, in the amount of 0.1 to 2 part of peroxide per hundred parts of the polyester, and
(C) Optionally, stabililizers such as ULTRANOX 626, and peroxide deactivate the catalytic system used for the aforementioned reactive extrusion process, in the amount of 0.1 to 2 part of stabilizer per hundred parts of the polyester, and
(D) Optionally, fillers and reinforcements employed in plastics, in an amount up to 40% by weight of the composition.

The following non-limiting procedures and examples are used to further describe the invention and illustrate some of the highlights of the invention. Examples are intended to be illustrative only, and that the invention is not intended to be limited to materials, conditions, process parameters and the like recited herein. Parts and percentages are by weight unless indicated.

### EXAMPLES AND COMPARATIVE EXPERIMENTS

### Comparative Example 1

### Sample A

Preparation of a simple melt-blending of ECOFLEX (poly(butylene adipate co-terephtalate)) as an aliphatic-aromatic copolyester (70 wt % of the total composition) with talc as an inorganic filler 700 g of ECOFLEX FBX 7011 having a number-average molecular weight of 43,510 and a polydispersity index of 2.30 determined by size-exclusion chromatography according to a polystyrene calibration, and 300 g of talc were hand-mixed, and fed to a Century ZSK-30 co-rotating twin screw extruder at a feed rate of 100 g/min. Barrel and die temperatures were maintained by means of ten electrical/cooling devices as shown in Table 1. The screw diameter was of 30 mm, and the length-to-diameter ratio of 42:1. The screw speed was 130 rpm resulting in a mean time residence of about 5 minutes. The strand was extruded through a mono-hole die having a nozzle opening of 2.7 mm in diameter, cooled down into a water-bath, and pelletized downstream. Melt-Flow Index was 3.89 g/10 min as determined by using a Ray-Ran melt flow indexer at 190° C. with a 2.16 kg load. A composition of 72 weight % in polyester was determined by selective extraction of polyester through solubilization of the melt-blend in chloroform, separation by ultracentrifugation of polyester fraction (supernatant) at 4000 rpm for 1 h, and evaporation of chloroform from the supernatant. This composition of polyester is in good agreement with the expected value based on thermogravimetric analysis (72 weight %). A number average molecular weight of 41,660 and a polydispersity index of 2.63 were determined for the extracted polyester by size exclusion chromatography according to a polystyrene calibration.

TABLE 1
Temperature profile used for the reactive extrusion process

| | Zone | | | | | | | | | |
|---|---|---|---|---|---|---|---|---|---|---|
| | 1 | 2 | 3 | 4 | 5 | 6 | 7 | 8 | 9 | Die |
| T(° C.) | 15 | 115 | 145 | 165 | 175 | 180 | 180 | 180 | 180 | 180 |

### Preparation Example 2

Preparation of reactively modified ECOFLEX (poly(butylene adipate co-terephtalate)) as an aliphatic-aromatic copolyester to be reactively melt-blended with talc as an inorganic filler 1000 g of ECOFLEX FBX 7011 having a number average molecular weight of 43,510 and a polydispersity index of 2.30 determined by size exclusion chromatography according to a polystyrene calibration, 30 g of maleic anhydride (3% by weight of ECOFLEX) as an unsaturated compounds bearing polar group(s), and 5 g of 2,5-dimethyl-2,5-di-(tert-butylperoxy)hexane (LUPEROX 101) (0.5% by weight of ECOFLEX) as a free-radical initiator were hand-mixed, and fed to a Century ZSK-30 co-rotating twin screw extruder. Barrel and die temperatures were maintained by means of ten electrical/cooling devices as shown in Table 1. The screw diameter was of 30 mm, and the length-to-diameter ratio of 42:1. The screw speed was 130 rpm resulting in a mean time residence of about 5 minutes. The resulting strand, so-called maleated ECOFLEX was extruded through a mono-hole die having a nozzle opening of 2.7 mm in diameter, cooled down into a water-bath, and pelletized downstream. The molecular weight of the resulting aliphatic aromatic copolyester is 36,620 with a polydispersity index of 3.19 as determined by size-exclusion chromatography according to a polystyrene calibration. 0.94 weight % of grafted maleic anhydride was determined by potentiometric back titration of maleic anhydride using morpholine and hydrochloric acid in a mixture of chloroform/methanol (3:2 in volume), according to the Johnson and Funk's method (Jonhson, J. B.; Funk G. L. Anal. Chem. 1955, Johnson 27, 9).

### Example 2

### Sample B

Reactive melt-blending of reactively modified ECOFLEX (poly(butylene adipate co-terephtalate)) as an aliphatic-aromatic copolyester (70 wt % of the total composition) with talc as an inorganic filler without catalyst through a two-step reactive extrusion process 700 g of the maleated-ECOFLEX as prepared in preparation Example 2, and 300 g of talc were hand-mixed, and fed to a Century ZSK-30 co-rotating twin-screw extruder at a feed rate of 100 g/min. The screw diameter was of 30 mm, and the length-to-diameter ratio of 42:1. The screw speed was 130 rpm resulting in a mean time residence of about 5 minutes. Barrel and die temperatures were maintained by means of ten electrical/cooling devices as shown in Table 1. The strand was extruded through a mono-hole die having a nozzle opening of 2.7 mm in diameter, cooled down into a water-bath, and pelletized downstream. Melt-Flow Index was 1.73 g/10 min as determined by using a Ray-Ran melt flow indexer at 190° C. with a 2.16 kg load. 73 weight % of the polyester part was selectively extracted through solubilization of the melt-blend in chloroform, separation by ultracentrifugation of polyester fraction (supernatant) at 4000 rpm for 1 h, and evaporation of chloroform from the supernatant. This composition is not in agreement with the expected value based on thermogravimetric analysis (70 weight %), which suggests that some of talc was extracted along with the polyester. This may be due to some grafting of reactively modified polyester onto talc. A number average molecular weight of 37,520 and a polydispersity index of 3.16 were determined for the extracted polyester by size exclusion chromatography according to a polystyrene calibration.

### Example 3

### Sample C

Reactive melt-blending of reactively modified ECOFLEX (poly(butylene adipate-co-terephtalate)) as an aliphatic-aromatic copolyester (70 wt % of the total composition) with talc as an inorganic filler in the presence of tin (II) octoate (0.35 wt % of the total composition) as a Lewis Acid catalyst through a two-step reactive extrusion process 700 g of the maleated-ECOFLEX as prepared in preparation Example 2, 3.5 g of tin (II) octanoate as a Lewis Acid Catalyst, and 300 g of talc were hand-mixed and fed to a Century ZSK-30 co-rotating twin-screw extruder at a feed rate of 10 g/min. The screw diameter was of 30 mm, and the length-to-diameter ratio of 42:1. Barrel and die temperatures were maintained by means of ten electrical/cooling devices as shown in Table 1. The screw speed was 130 rpm resulting in a mean time residence of about 5 minutes. The strand was extruded through a mono-hole die having a nozzle opening of 2.7 mm in diameter, cooled down into a water-bath, and pelletized downstream. Melt-Flow Index was 23.28 g/10 min as determined by using a Ray-Ran melt flow indexer at 190° C. with a 2.16 kg load. 78 weight % of the polyester part was selectively extracted through solubilization of the melt-blend in chloroform, separation by ultracentrifugation of polyester fraction (supernatant) at 4000 rpm for 1 h, and evaporation of chloroform from the supernatant. This composition is not in agreement with the expected value based on thermogravimetric analysis (70 weight %), which suggests that some of talc was extracted along with the polyester. This may be due to some grafting of reactively modified polyester onto talc. A number average molecular weight of 24,280 and a polydispersity index of 2.45 were determined for the extracted polyester by size-exclusion chromatography according to a polystyrene calibration.

### Example 4

### Sample D

Reactive melt-blending of reactively modified ECOFLEX (poly(butylene adipate co-terephtalate)) as an aliphatic-aromatic copolyester (70 wt % of the total composition) with talc as an inorganic filler in the presence of tin (II) octoate (0.70 wt % of the total composition) as a Lewis Acid catalyst through a two-step reactive extrusion process 700 g of the maleated-ECOFLEX as prepared in preparation Example 2.7 g of tin (II) octanoate as a Lewis Acid Catalyst, and 300 g of talc were hand-mixed and fed to a Century ZSK-30 co-rotating twin-screw extruder at a feed rate of 100 g/min. The screw diameter was of 30 mm, and the length-to-diameter ratio of 42:1. Barrel and die temperatures were maintained by means of ten electrical/cooling devices as shown in Table 1. The screw speed was 130 rpm resulting in a mean time residence of about 5 minutes. The strand was extruded through a mono-hole die having a nozzle opening of 2.7 mm in diameter, cooled down into a water-bath, and pelletized downstream. Melt-Flow Index was 16.60 g/10 min as determined by using a Ray-Ran melt flow indexer at 190° C. with a 2.16 kg load. 77 weight % of the polyester part was selectively extracted through solubilization of the melt-blend in chloroform, separation by ultracentrifugation of polyester fraction (supernatant) at 4000 rpm for 1 h, and evaporation of chloroform from the supernatant. This composition is not in agreement with the expected value based on thermogravimetric analysis (70 weight %), which suggests that some of talc was extracted along with the polyester. This may be due to some grafting of reactively modified polyester onto talc. A number average molecular weight of 20,080 and a polydispersity index of 2.44 were determined for the extracted polyester by size exclusion chromatography according to a polystyrene calibration.

### Example 5

### Sample E

Reactive melt-blending of reactively modified ECOFLEX (poly(butylene adipate co-terephtalate)) as an aliphatic-aromatic copolyester (70 wt % of the total composition) with talc as an inorganic filler in the presence of 4-dimethylaminopyridine (0.35 wt % of the total composition) as a Lewis base catalyst through a two-step reactive extrusion process 700 g of the maleated-ECOFLEX as prepared in preparation Example 2, 3.5 g of 4-dimethylamino pyridine (0.5% by weight of Maleated ECOFLEX) and 300 g of talc were hand-mixed and fed to a Century ZSK-30 co-rotating twin-screw extruder at a feed rate of 100 g/min. The screw diameter was of 30 mm, and the length-to-diameter ratio of 42:1 Barrel and die temperatures were maintained by means of ten electrical/cooling devices as shown in Table 1. The screw speed was 130 rpm resulting in a mean time residence of about 5 minutes. The strand was extruded through a mono-hole die having a nozzle opening of 2.7 mm in diameter, cooled down into a water-bath, and pelletized downstream. Melt-Flow Index was 8.18 g/10 min as determined by using a Ray-Ran melt flow indexer at 190° C. with a 2.16 kg load. 73 weight % of the polyester part was selectively extracted through solubilization of the melt-blend in chloroform, separation by ultracentrifugation of polyester fraction (supernatant) at 4000 rpm for 1 h, and evaporation of chloroform from the supernatant. This composition is not in agreement with the expected value based on thermogravimetric analysis (70 weight %), which suggests that some of talc was extracted along with the polyester. This may be due to some grafting of reactively modified polyester onto talc. A number average molecular weight of 36,340 and a polydispersity index of 2.60 were determined for the extracted polyester by size exclusion chromatography according to a polystyrene calibration.

### Example 6

### Sample F

Reactive melt-blending of reactively modified ECOFLEX (poly(butylene adipate co-terephtalate)) as an aliphatic-aromatic copolyester (70 wt % of the total composition) with talc as an inorganic filler without catalyst through a one-step reactive extrusion process 700 g of ECOFLEX FBX 7011 having a number average molecular weight of 43,510 and a polydispersity index of 2.30 determined by size exclusion chromatography according to a polystyrene calibration, 21 g of maleic anhydride (3% by weight of ECOFLEX) as an unsaturated compounds bearing polar group(s), 3.5 g of 2,5-dimethyl-2,5-di-(tert-butylperoxy) hexane (LUPEROX 101) (0.5% by weight of ECOFLEX) as a free radical initiator, and 300 g of talc were hand-mixed, and fed to a Century ZSK-30 co-rotating twin screw extruder at a feed rate of 100 g/min. The screw diameter was of 30 mm, and the length-to-diameter ratio of 42:1. Barrel and die temperatures were maintained by means of ten electrical/cooling devices as shown in Table 1. The screw speed was 130 rpm resulting in a mean time residence of about 5 minutes. The strand was extruded through a mono-hole die having a nozzle opening of 2.7 mm in diameter, cooled down into a water-bath, and pelletized downstream. Melt-Flow Index was 4.37 g/10 min as determined by using a Ray-Ran melt flow indexer at 190° C. with a 2.16 kg load. 74 weight % of the polyester part was selectively extracted through solubilization of the melt-blend in chloroform, separation by ultracentrifugation of polyester fraction (supernatant) at 4000 rpm for 1 h, and evaporation of chloroform from the supernatant. This composition is not in agreement with the expected value based on thermogravimetric analysis (70 weight %), which suggests that some of talc was extracted along with the polyester. This may be due to some grafting of reactively modified polyester onto talc. A number average molecular weight of 47,190 and a polydispersity index of 2.21 were determined for the extracted polyester by size exclusion chromatography according to a polystyrene calibration.

### Example 7

### Sample G

Reactive melt-blending of reactively ECOFLEX (poly(butylene adipate co-terephtalate)) as an aliphatic-aromatic copolyester (70 wt % of the total composition) with talc as an inorganic filler in the presence of tin (II) octoate (0.35 wt % of the total composition) as a Lewis Acid catalyst through a one-step reactive extrusion process 700 g of ECOFLEX FBX 7011 having a number average molecular weight of 43,510 and a polydispersity index of 2.30 determined by size exclusion chromatography according to a polystyrene calibration, 21 g of maleic anhydride (3% by weight of ECOFLEX) as an unsaturated compounds bearing polar group(s), 3.5 g of 2,5-dimethyl-2,5-di-(tert-butylperoxy)hexane (LUPEROX 101) (0.5% by weight of ECOFLEX) as a free-radical initiator, and 300 grams of talc were hand-mixed, and fed to a Century ZSK-30 co-rotating twin screw extruder at a feed rate of 100 g/min. Tin (II) octanoate was pumped at a feed rate of 0.35 g/min (0.5% by weight of maleated-ECOFLEX), at an inlet port 20D downstream of the feed port. The screw diameter was of 30 mm, and the length-to-diameter ratio of 42:1. Barrel and die temperatures were maintained by means of ten electrical/cooling devices as shown in Table 1. The screw speed was 130 rpm resulting in a mean time residence of about 5 minutes. The strand was extruded through a mono-hole die having a nozzle opening of 2.7 mm in diameter, cooled down into a water-bath, and pelletized downstream. Melt-Flow Index was 34.43 g/10 min as determined by using a Ray-Ran melt flow indexer at 190° C. with a 2.16 kg load. 76 weight % of the polyester part was selectively extracted through solubilization of the melt-blend in chloroform, separation by ultracentrifugation of polyester fraction (supernatant) at 4000 rpm for 1 h, and evaporation of chloroform from the supernatant. This composition is not in agreement with the expected value based on thermogravimetric analysis (70 weight %), which suggests that some of talc was extracted along with the polyester. This may be due to some grafting of reactively modified polyester onto talc. A number average molecular weight of 15,670 and a polydispersity index of 4.23 were determined for the extracted polyester by size exclusion chromatography according to a polystyrene calibration.

### Example 8

### Sample H

Reactive melt-blending of reactively modified ECOFLEX (poly(butylene adipate co-terephtalate)) as an aliphatic-aromatic copolyester (70 wt % of the total composition) with talc as an inorganic filler in the presence of tin (II) octoate (0.70 wt % of the total composition) as a Lewis Acid catalyst through a one-step reactive extrusion process 700 g of ECOFLEX FBX 7011 having a number average molecular weight of 43,510 and a polydispersity index of 2.30 determined by size exclusion chromatography according to a polystyrene calibration, 21 g of maleic anhydride (3% by weight of ECOFLEX) as an unsaturated compounds bearing polar group(s), 3.5 g of 2,5-dimethyl-2,5-di-(tert-butylperoxy)hexane (LUPEROX 101) (0.5% by weight of ECOFLEX) as a free radical initiator, and 300 g of talc were hand-mixed, and fed together to a Century ZSK-30 co-rotating twin screw extruder at a feed rate of 100 g/min. Tin (II) octanoate was pumped at a feed rate of 0.7 g/min, at an inlet port 20D downstream of the feed port. The screw diameter was of 30 mm, and the length-to-diameter ratio of 42:1. Barrel and die temperatures were maintained by means of ten electrical/cooling devices as shown in Table 1. The screw speed was 130 rpm resulting in a mean time residence of about 5 minutes. The strand was extruded through a mono-hole die having a nozzle opening of 2.7 mm in diameter, cooled down into a water-bath, and pelletized downstream. Melt-Flow Index was 35.65 g/10 min as determined by using a Ray-Ran melt flow indexer at 190° C. with a 2.16 kg load. 75 weight % of the polyester part was selectively extracted through solubilization of the melt-blend in chloroform, separation by ultracentrifugation of polyester fraction (supernatant) at 4000 rpm for 1 h, and evaporation of chloroform from the supernatant. This composition is not in agreement with the expected value based on thermogravimetric analysis (70 weight %), which suggests that some of talc was extracted along with the polyester. This may be due to some grafting of reactively modified polyester onto talc. A number average molecular weight of 18,920 and a polydispersity index of 2.33 were determined for the extracted polyester by size exclusion chromatography according to a polystyrene calibration.

### Example 9

### Sample I

Reactive melt-blending of reactively ECOFLEX (poly(butylene adipate co-terephtalate)) as an aliphatic-aromatic copolyester (80 wt % of the total composition) with talc as an inorganic filler in the presence of tin (II) octoate (0.8 wt % of the total composition) as a Lewis Acid catalyst through a one-step reactive extrusion process 800 g of ECOFLEX FBX 7011 having a number average molecular weight of 43,510 and a polydispersity index of 2.30 determined by size exclusion chromatography according to a polystyrene calibration, 24 g of maleic anhydride (3% by weight of ECOFLEX) as an unsaturated compounds bearing polar group(s), 4 g of 2,5-dimethyl-2,5-di-(tert-butylperoxy)hexane (LUPEROX 101) (0.5% by weight of ECOFLEX) as a free-radical initiator, and 200 grams of talc were hand-mixed, and fed to a Century ZSK-30 co-rotating twin screw extruder at a feed rate of 100 g/min. Tin (II) octanoate was pumped at a feed rate of 0.8 g/min, at an inlet port 20D downstream of the feed port. The screw diameter was of 30 mm, and the length-to-diameter ratio of 42:1. Barrel and die temperatures were maintained by means of ten electrical/cooling devices as shown in Table 1. The screw speed was 130 rpm resulting in a mean time residence of about 5 minutes. The strand was extruded through a mono-hole die having a nozzle opening of 2.7 mm in diameter, cooled down into a water-bath, and pelletized downstream. Melt-Flow Index was 30.65 g/10 min as determined by using a Ray-Ran melt flow indexer at 190° C. with a 2.16 kg load. 83 weight % of the polyester part was selectively extracted through solubilization of the melt-blend in chloroform, separation by ultracentrifugation of polyester fraction (supernatant) at 4000 rpm for 1 h, and evaporation of chloroform from the supernatant. This composition is not in agreement with the expected value based on thermogravimetric analysis (70 weight %), which suggests that some of talc was extracted along with the polyester. This may be due to some grafting of reactively modified polyester onto talc. A number average molecular weight of 13,950 and a polydispersity index of 2.54 were determined for the extracted polyester by size exclusion chromatography according to a polystyrene calibration.

### Example 10

### Sample J

Reactive melt-blending of reactively modified ECOFLEX (poly(butylene adipate co-terephtalate)) as an aliphatic-aromatic copolyester (60 wt % of the total composition) with talc as an inorganic filler in the presence of tin (II) octoate (0.50 wt % of the total composition) as a Lewis Acid catalyst through a one-step reactive extrusion process 600 g of ECOFLEX FBX 7011 having a number average molecular weight of 43,510 and a polydispersity index of 2.30 determined by size exclusion chromatography according to a polystyrene calibration, 18 g of maleic anhydride (3% by weight of ECOFLEX) as an unsaturated compounds bearing polar group(s), 3.0 g of 2,5-dimethyl-2,5-di-(tert-butylperoxy)hexane (LUPEROX 101) (0.5% by weight of ECOFLEX) as a free radical initiator, and 400 g of talc were hand-mixed, and fed together to a Century ZSK-30 co-rotating twin screw extruder at a feed rate of 120 g/min. Tin (II) octanoate was pumped at a feed rate of 0.72 g/min, at an inlet port 20D downstream of the feed port. The screw diameter was of 30 mm, and the length-to-diameter ratio of 42:1. Barrel and die temperatures were maintained by means of ten electrical/cooling devices as shown in Table 1. The screw speed was 130 rpm resulting in a mean time residence of about 5 minutes. The strand was extruded through a mono-hole die having a nozzle opening of 2.7 mm in diameter, cooled down into a water-bath, and pelletized downstream. Melt-Flow Index was 20.35 g/10 min as determined by using a Ray-Ran melt flow indexer at 190° C. with a 2.16 kg load. 69 weight % of the polyester part was selectively extracted through solubilization of the melt-blend in chloroform, separation by ultracentrifugation of polyester fraction (supernatant) at 4000 rpm for 1 h, and evaporation of chloroform from the supernatant. This composition is not in agreement with the expected value based on thermogravimetric analysis (70 weight %), which suggests that some of talc was extracted along with the polyester. This may be due to some grafting of reactively modified polyester onto talc. A number average molecular weight of 15,230 and a polydispersity index of 2.66 were determined for the extracted polyester by size exclusion chromatography according to a polystyrene calibration.

### Example 11

### Sample K

Reactive melt-blending of reactively modified ECOFLEX (poly(butylene adipate co-terephtalate)) as an aliphatic-aromatic copolyester (52 wt % of the total composition) with talc as an inorganic filler in the presence of tin (II) octoate (0.40 wt % of the total composition) as a Lewis Acid catalyst through a one-step reactive extrusion process 520 g of ECOFLEX FBX 7011 having a number average molecular weight of 43,510 and a polydispersity index of 2.30 determined by size exclusion chromatography according to a polystyrene calibration, 15.6 g of maleic anhydride (3% by weight of ECOFLEX) as an unsaturated compounds bearing polar group(s), 2.6 g of 2,5-dimethyl-2,5-di-(tert-butylperoxy)hexane (LUPEROX 101) (0.5% by weight of ECOFLEX) as a free radical initiator, and 480 g of talc were hand-mixed, and fed together to a Century ZSK-30 co-rotating twin screw extruder at a feed rate of 135 g/min. Tin (II) octanoate was pumped at a feed rate of 0.7 g/min, at an inlet port 20D downstream of the feed port. The screw diameter was of 30 mm, and the length-to-diameter ratio of 42:1. Barrel and die temperatures were maintained by means of ten electrical/cooling devices as shown in Table 1. The screw speed was 130 rpm resulting in a mean time residence of about 5 minutes. The strand was extruded through a mono-hole die having a nozzle opening of 2.7 mm in diameter, cooled down into a water-bath, and pelletized downstream. Melt-Flow Index was 12.60 g/10 min as determined by using a Ray-Ran melt flow indexer at 190° C. with a 2.16 kg load. 77 weight % of the polyester part was selectively extracted through solubilization of the melt-blend in chloroform, separation by ultracentrifugation of polyester fraction (supernatant) at 4000 rpm for 1 h, and evaporation of chloroform from the supernatant. This composition is not in agreement with the expected value based on thermogravimetric analysis (70 weight %), which suggests that some of talc was extracted along with the polyester. This may be due to some grafting of reactively modified polyester onto talc. A number average molecular weight of 25,400 and a polydispersity index of 2.29 were determined for the extracted polyester by size exclusion chromatography according to a polystyrene calibration.

### Preparation Example 12

Reactive melt-blending of reactively modified ECOFLEX (poly(butylene adipate co-terephtalate)) as an aliphatic-aromatic copolyester (40 wt % of the total composition) with talc as an inorganic filler in the presence of tin (II) octoate (0.35 wt % of the total composition) as a Lewis Acid catalyst through a one-step reactive extrusion process 400 g of ECOFLEX FBX 7011 having a number average molecular weight of 43,510 and a polydispersity index of 2.30 determined by size exclusion chromatography according to a polystyrene calibration, 12 g of maleic anhydride (3% by weight of ECOFLEX) as an unsaturated compounds bearing polar group(s), 2.0 g of 2,5-dimethyl-2,5-di-(tert-butylperoxy)hexane (LUPEROX 101) (0.5% by weight of ECOFLEX) as a free radical initiator, and 600 g of talc were hand-mixed, and fed together to a Century ZSK-30 co-rotating twin screw extruder at a feed rate of 87 g/min. Tin (II) octanoate was pumped at a feed rate of 0.35 g/min, at an inlet port 20D downstream of the feed port. The screw diameter was of 30 mm, and the length-to-diameter ratio of 42:1. Barrel and die temperatures were maintained by means of ten electrical/cooling devices as shown in Table 1. The screw speed was 130 rpm resulting in a mean time residence of about 5 minutes. The strand was extruded through a mono-hole die having a nozzle opening of 2.7 mm in diameter, cooled down into a water-bath, and pelletized downstream. Melt-Flow Index was 0.38 g/10 min as determined by using a Ray-Ran melt flow indexer at 190° C. with a 2.16 kg load. 49 weight % of the polyester part was selectively extracted through solubilization of the melt-blend in chloroform, separation by ultracentrifugation of polyester fraction (supernatant) at 4000 rpm for 1 h, and evaporation of chloroform from the supernatant. This composition is not in agreement with the expected value based on thermogravimetric analysis (70 weight %), which suggests that some of talc was extracted along with the polyester. This may be due to some grafting of reactively modified polyester onto talc. A number average molecular weight of 23,490 and a polydispersity index of 3.06 were determined for the extracted polyester by size exclusion chromatography according to a polystyrene calibration.

### Example 12

### Sample L

Melt-Blending of 50wt % of ECOFLEX (poly(butylene adipate co-terephtalate)) and 50wt % of reactive melt-blending of reactively ECOFLEX with talc (60 wt % of the total composition) derived from the one-step reactive extrusion process 500 g of ECOFLEX FBX 7011 having a number average molecular weight of 43,510 and a polydispersity index of 2.30 determined by size exclusion chromatography according to a polystyrene calibration, and 500 g of reactively melt-blended of ECOFLEX with talc as prepared in preparation Example 12 were hand-mixed, and fed to a Century ZSK-30 co-rotating twin-screw extruder at a feed rate of 100 g/min. The screw diameter was of 30 mm, and the length-to-diameter ratio of 42:1. The screw speed was 130 rpm resulting in a mean time residence of about 5 minutes. Barrel and die temperatures were maintained by means of ten electrical/cooling devices as shown in Table 1. The strand was extruded through a mono-hole die having a nozzle opening of 2.7 mm in diameter, cooled down into a water-bath, and pelletized downstream. Melt-Flow Index was 8.26 g/10 min as determined by using a Ray-Ran melt flow indexer at 190° C. with a 2.16 kg load. 73 weight % of the polyester part was selectively extracted through solubilization of the melt-blend in chloroform, separation by ultracentrifugation of polyester fraction (supernatant) at 4000 rpm for 1 h, and evaporation of chloroform from the supernatant. This composition is not in agreement with the expected value based on thermogravimetric analysis (70 weight %), which suggests that some of talc was extracted along with the polyester. This may be due to some grafting of reactively modified polyester onto talc. A number average molecular weight of 41,330 and a polydispersity index of 2.22 were determined for the extracted polyester by size exclusion chromatography according to a polystyrene calibration.

### Example 13

### Sample M

Simple melt-blending of TONE (poly(ε-caprolactone)) as an aliphatic polyester (70 wt % of the total composition) with talc as an inorganic filler through a one-step reactive extrusion process 700 g of TONE P485 and 300 g of talc were hand-mixed, and fed to a Century ZSK-30 co-rotating twin screw extruder at a feed rate of 100 g/min. The screw diameter was of 30 mm, and the length-to-diameter ratio of 42:1. Barrel and die temperatures were maintained by means of ten electrical/cooling devices as shown in Table 1. The screw speed was 130 rpm resulting in a mean time residence of about 5 minutes. The strand was extruded through a mono-hole die having a nozzle opening of 2.7 mm in diameter, cooled down into a water-bath, and pelletized downstream.

### Example 14

### Sample N

Reactive melt-blending of reactively TONE (poly(ε-caprolactone)) as an aliphatic polyester (70 wt % of the total composition) with talc as an inorganic filler in the absence of catalyst through a one-step reactive extrusion process 700 g of TONE P485, 21 g of maleic anhydride (3% by weight of TONE) as an unsaturated compounds bearing polar group(s), 3.5 g of 2,5-dimethyl-2,5-di-(tert-butylperoxy)hexane (LUPEROX 101) (0.5% by weight of TONE) as a free-radical initiator, and 300 grams of talc were hand-mixed, and fed to a Century ZSK-30 co-rotating twin screw extruder at a feed rate of 100 g/min. The screw diameter was of 30 mm, and the length-to-diameter ratio of 42:1. Barrel and die temperatures were maintained by means of ten electrical/cooling devices as shown in Table 1. The screw speed was 130 rpm resulting in a mean time residence of about 5 minutes. The strand was extruded through a mono-hole die having a nozzle opening of 2.7 mm in diameter, cooled down into a water-bath, and pelletized downstream.

### Example 15

### Sample O

Reactive melt-blending of reactively TONE (poly(ε-caprolactone)) as an aliphatic polyester (70 wt % of the total composition) with talc as an inorganic filler in the presence of tin (II) octoate (0.70 wt % of the total composition) as a Lewis Acid catalyst through a one-step reactive extrusion process of 700 g of TONE P485, 21 g of maleic anhydride (3% by weight of TONE) as an unsaturated compounds bearing polar group(s), 3.5 g of 2,5-dimethyl-2,5-di-(tert-butylperoxy)hexane (LUPEROX 101) (0.5% by weight of TONE) as a free-radical initiator, and 300 grams of talc were hand-mixed, and fed to a Century ZSK-30 co-rotating twin screw extruder at a feed rate of 100 g/min. Tin (II) octanoate was pumped at a feed rate of 0.7 g/min, at an inlet port 20D downstream of the feed port. The screw diameter was of 30 mm, and the length-to-diameter ratio of 42:1. Barrel and die temperatures were maintained by means of ten electrical/cooling devices as shown in Table 1. The screw speed was 130 rpm resulting in a mean time residence of about 5 minutes. The strand was extruded through a mono-hole die having a nozzle opening of 2.7 mm in diameter, cooled down into a water-bath, and pelletized downstream.

### Example 16

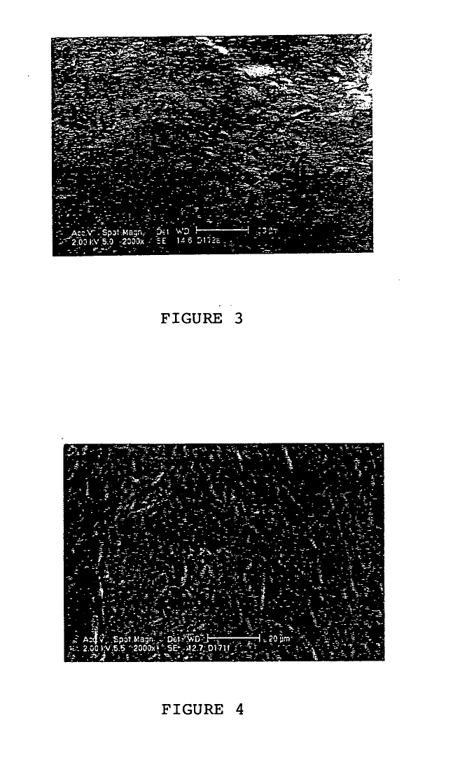

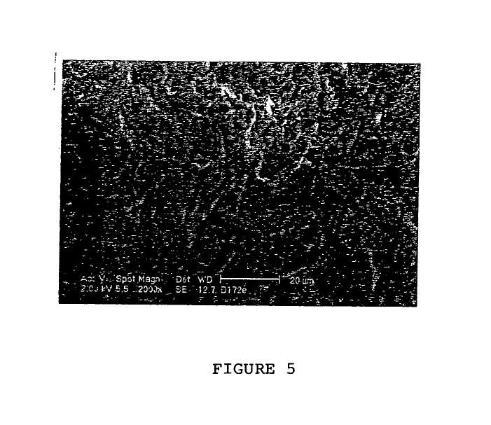

SEM analysis was carried out on the cryofractured surface of sample A prepared by simple melt-blending (FIG. 3), the sample D prepared by the two-step reactive extrusion process in the presence of catalyst (FIG. 4), and the sample H prepared by the one-step reactive extrusion process in the presence of catalyst (FIG. 5). FIG. 3 shows that the cryofractured surface of the sample A prepared by simple melt-blending is characterized by empty zones between the polyester matrix and filler due to a fracture, which proceeds through the equatorial position. In contrast, any empty zone or depasting was not observed for the reactive melt-blending of reactively modified polyester with talc in the presence of catalyst through the two-step and one-step reactive extrusion process. The microparticles are contained into the polyester matrix, which attests that the fracture propagated through the polyester matrix. These Examples demonstrate that the two-step and one-step reactive extrusion process in the presence of catalyst allow improving the interfacial adhesion between the polyester chains and the filler.

### Example 17

The products obtained from Examples 1 to 8 were extruded into films a Killion single-screw blown film unit. The screw diameter was 25.4 mm with a length-to-diameter ratio of 25:1. The die inner diameter was 50.8 mm with a die gap size of 1.5 mm. The blown film processing conditions are shown in Table 2. Tensile properties of the films were determined using INSTRON Mechanical Testing Equipment fitted with a 100 lbs load cell. The crosshead speed was 20 cm per minute. Rectangular film samples, 4 inches×1 inch dimension cut along the machine direction were conditioned at 23° C. and 50% Relative Humidity for 40 hours before being tested according to ASTM D-882 testing.

TABLE 2
Temperature profile used for blown films

| | Zone | | | | | | | |
|---|---|---|---|---|---|---|---|---|
| | | | | Clamp | Adap- | | | |
| | 1 | 2 | 3 | Ring | tor | Die 1 | Die 2 | Die 3 |
| T(° C.) | 150 | 150 | 150 | 135 | 130 | 125 | 125 | 25 |

Table 3 gives an overview of the resulting tensile properties for the samples A to H. Comparing the sample A prepared by simple melt-blending to the samples B to H prepared by the one-step/two-step reactive extrusion processes, the tensile properties of the samples B to H can be improved via the one-step/two-step reactive extrusion processes, while keeping high elongation at break close to 500-600. Comparing the sample B prepared by the two-step reactive extrusion process in the absence of catalyst to the sample C to E in the presence of catalyst, the addition of catalysts improves considerably the tensile properties of reactively melt-blending of ECOFLEX as an aliphatic-aromatic co-polyester with talc as an inorganic filler, while keeping high elongation at break higher than 480%. Comparing the sample F prepared by one-step reactive extrusion process in the absence of catalyst to the sample G to H in the presence of tin octoate as a catalytic system, the addition of catalysts improves considerably the tensile properties of reactively melt-blending of ECOFLEX as an aliphatic-aromatic co-polyester with talc as an inorganic filler, while keeping high elongation at break higher than 600%. Comparing the sample C prepared by the two-step reactive extrusion process in the presence of 0.35 wt % of tin octoate as a catalytic system to the sample G prepared by the one-step reactive extrusion process in the presence of 0.35 wt % of tin octoate as a catalytic system, the compositions derived from the one-step reactive extrusion process have better tensile properties than ones derived from the two-step reactive extrusion process. Comparing the sample D prepared by the two-step reactive extrusion process in the presence of 0.7 wt % of tin octoate as a catalytic system to the sample H prepared by the one-step reactive extrusion process in the presence of 0.7 wt % of tin octoate as a catalytic system, the compositions derived from the one-step reactive extrusion process have better tensile properties than ones derived from the two-step reactive extrusion process.

TABLE 3
Tensile properties of blown films derived from the Examples 1-8 (machine direction)

| | | | Young's Modulus | Yield Stress | Tensile Stress | Break |
|---|---|---|---|---|---|---|
| Sample | Process | Catalyst^{a)} | (MPa) | (MPa) | (MPa) | Elongation (%) |
| A | Simple melt-blending | — | 117.3 | 12.7 | 14.20 | 600 |
| B | Two-step reactive extrusion | — | 110.0 | 18.6 | 18.8 | 460 |
| C | Two-step reactive extrusion | 0.35 wt % in tin octoate | 227.5 | 27.2 | 27.2 | 630 |
| D | Two-step reactive extrusion | 0.70 wt % in tin octoate | 192.3 | 25.8 | 25.8 | 500 |
| E | Two-step reactive extrusion | 0.35 wt % in 4-Dimthylamino- | 232.5 | 19.4 | 22.1 | 480 |
| | | pyridine | | | | |
| F | One-step reactive extrusion | — | 183.8 | 21.5 | 21.6 | 530 |
| G | One-step reactive extrusion | 0.35 wt % in tin octoate | 219.0 | 28.4 | 28.4 | 640 |
| H | One-step reactive extrusion | 0.70 wt % in tin octoate | 216.8 | 26.9 | 27.3 | 630 |

^{a)}Determined with regard to the total composition

These Examples demonstrate that the compositions derived from the aforementioned one-step reactive extrusion process for reactively melt-blending in situ reactively modified ECOFLEX as an aliphatic-aromatic co-polyester with talc as an inorganic filler have tensile properties better than ones derives from the simple/two-step reactive extrusion melt-blending of ECOFLEX as an aliphatic-aromatic co-polyester with talc as an inorganic filler. In addition, the use of catalyst is beneficial for improving the chemical or physical bonds as attested by the values of tensile properties of reactively modified ECOFLEX to inorganic fillers.

### Example 18

The products obtained from Examples 8 to 11 were extruded into films a Killion single-screw blown film unit. The screw diameter was 25.4 mm with a length-to-diameter ratio of 25:1. The die inner diameter was 50.8 mm with a die gap size of 1.5 mm. The blown film processing conditions are shown in Table 2. Tensile properties of the films were determined using INSTRON Mechanical Testing Equipment fitted with a 100 lbs load cell. The crosshead speed was 20 cm per minute. Rectangular film samples, 4 inches×1 inch dimension cut along the machine direction were conditioned at 23° C. and 50% Relative Humidity for 40 hours before being tested according to ASTM D-882 testing. Table 4 gives an overview of the resulting tensile properties for the samples H to K. Comparing the samples H to K, the increase of talc amount enhances the tensile properties of compositions derived from the one-step reactive extrusion process for reactively melt-blending ECOFLEX as an aliphatic-aromatic co-polyester with talc as an inorganic filler, while keeping an acceptable elongation at break higher than 260%.

TABLE 4
Tensile properties of blown films derived
from the Examples 8-11 (machine direction)

| | Talc | Young's | Yield | Tensile | Break |
|---|---|---|---|---|---|
| | Load^{a)} | Modulus | Stress | Stress | Elonga- |
| Sample | (%) | (MPa) | (MPa) | (MPa) | tion (%) |
| H | 30 | 216.8 | 26.9 | 27.3 | 630 |
| I | 20 | 163.2 | 24.2 | 24.2 | 670 |
| J | 40 | 333.2 | 22.4 | 26.3 | 440 |
| K | 48 | 371.7 | 22.4 | 24.11 | 260 |

^{a)}Determined with regard to the total composition

### Example 19

The products obtained from Examples 8 and 12 were extruded into films a Killion single-screw blown film unit. The screw diameter was 25.4 mm with a length-to-diameter ratio of 25:1. The die inner diameter was 50.8 mm with a die gap size of 1.5 mm. The blown film processing conditions are shown in Table 2. Tensile properties of the films were determined using INSTRON Mechanical Testing Equipment fitted with a 100 lbs load cell. The crosshead speed was 20 cm per minute. Rectangular film samples, 4 inches×1 inch dimension cut along the machine direction were conditioned at 23° C. and 50% Relative Humidity for 40 hours before being tested according to ASTM D-882 testing. Table 5 gives an overview of the resulting tensile properties for the sample L and H.

TABLE 5
Tensile properties of blown films derived
from the Examples 1-8 (machine direction)

| | | Talc | Young's | Yield | Tensile | Break |
|---|---|---|---|---|---|---|
| | | load^{a)} | Modulus | Stress | Stress | Elonga- |
| Sample | Process | (%) | (MPa) | (MPa) | (MPa) | tion (%) |
| L | Blend from | 30 | 349.1 | 36.3 | 36.4 | 730 |
| | Modified | | | | | |
| | Ecoflex | | | | | |
| H | One-step | 30 | 216.8 | 26.9 | 27.3 | 630 |
| | reactive | | | | | |
| | extrusion | | | | | |

^{a)}Determined with regard to the total composition

These Examples demonstrate that the re-melt-blending of reactively melt-blends with a high talc load derived from the aforementioned one-step reactive extrusion process with pure ECOFLEX enables the preparation of blend compositions having better tensile properties, and high elongation at break than ones derived directly from the one-step reactive extrusion process by comparison to the same talc load.

### Example 20

The products obtained from Examples 13 to 15 were extruded into films a Killion single-screw blown film unit. The screw diameter was 25.4 mm with a length-to-diameter ratio of 25:1. The die inner diameter was 50.8 mm with a die gap size of 1.5 mm. The blown film processing conditions are shown in Table 6. Tensile properties of the films were determined using INSTRON Mechanical Testing Equipment fitted with a 100 lbs load cell. The crosshead speed was 20 cm per minute. Rectangular film samples, 4 inches×1 inch dimension cut along the machine direction were conditioned at 23° C. and 50% Relative Humidity for 40 hours before being tested according to ASTM D-882 testing.

TABLE 6
Temperature profile used for blown films

| | Zone | | | | | | | |
|---|---|---|---|---|---|---|---|---|
| | | | | Clamp | Adap- | | | |
| | 1 | 2 | 3 | Ring | tor | Die 1 | Die 2 | Die 3 |
| T(° C.) | 130 | 130 | 120 | 120 | 110 | 105 | 100 | 25 |

Table 7 gives an overview of the resulting tensile properties for the samples M to O.

TABLE 7
Tensile properties of blown films derived from the Examples 13-15 (machine direction)

| | | | Young's Modulus | Yield Stress | Tensile Stress | Break Elongation |
|---|---|---|---|---|---|---|
| Sample | Process | Catalyst^{a)} | (MPa) | (MPa) | (MPa) | (%) |
| M | Simple melt-blending | — | 506.5 | 16.3 | 20.7 | 570 |
| N | One-step reactive extrusion | — | 725.0 | 26.9 | 27.5 | 160 |
| O | One-step reactive extrusion | 0.70 wt % in tin octoate | 903.1 | 30.0 | 31.0 | 275 |

^{a)}Determined with regard to the total composition

These Examples demonstrate that the compositions derived from the aforementioned one-step reactive extrusion process for reactively melt-blending in situ reactively modified TONE as an other aliphatic polyester with talc as an inorganic filler have tensile properties better than ones derived from the simple reactive extrusion melt-blending of TONE as an aliphatic polyester with talc as an inorganic filler. In addition, the use of catalyst is beneficial for improving the chemical or physical bonds as well as the tensile properties of reactively modified TONE to inorganic fillers. Finally, such a one-step reactive extrusion process shows to be useful for reactively melt-blending in situ reactively modified any aliphatic polyesters/aliphatic-aromatic co-polyesters with an inorganic filler such as talc.

It is intended that the foregoing description be only illustrative of the present invention and that the present invention be limited only by the hereinafter appended claims.

We claim:

1. A composite composition which comprises:
(a) a reactively blended polyester polymer which has been reactively blended with an organic anhydride to provide an anhydride modified polymer; and
(b) an inorganic filler having hard surface exposed hydroxyl groups which were also reacted with the anhydride modified polymer, the filler being present in an amount between about 15 and 40% by weight of the composition.

2. The composition of claim 1 wherein the reactively blended polymer of (a) has been produced before having been reactively blended with the filler of (b).

3. The composition of claim 1 wherein the reactively blended polymer of (a) has been produced simultaneously with the reactively blended filler of (b).

4. The compositions of any one of claims 1, 2 or 3 wherein the polyester is poly(butylenes adipate co-terephtalate).

5. The composition of any one of claims 1, 2 or 3 wherein the anhydride is maleic anhydride.

6. The composition of any one of claims 1, 2 or 3 wherein the polyester is poly(butylenes adipate co-terephtalate) and the anhydride is maleic anhydride.

7. The composition of any one of claims 1, 2 or 3 wherein the composition has been further reacted with a Lewis acid or Lewis base which produces an increased molecular weight of the anhydride modified polymer.

8. The composition of claim 1 which has been reacted with a free radical initiator for the reaction of the organic anhydride with the polyester polymer.

9. The composition of claims 1, 2 or 3 wherein the filler is talc.

10. A reactively blended composition which comprises:
(a) an organic anhydride modified polyester polymer with a free radical initiator for the reaction of the organic anhydride with the polyester polymer;
(b) an inorganic filler having exposed surface hydroxyl groups reacted with the anhydride modified polyester polymer, the filler being present in an amount between about 15 and 40% by weight of the composition; and
(c) a Lewis acid or Lewis base which produces an increased molecular weight of the anhydride modified polyester polymer in an amount of less than about 5% by weight of the composition.

11. The composition of claim 10 or 11 wherein the polyester polymer is biodegradable.

12. The composition of claim 10 or 11 wherein the polyester is poly(butylenes adipate co-terephtalate).

13. The composition of claim 10 or 11 wherein the anhydride is maleic anhydride.

14. The composition of claim 10 or 11 wherein the polyester is poly(butylenes adipate co-terephtalate) and the anhydride is maleic anhydride.

15. The composition of claim 10 or 11 wherein the Lewis acid is tin octonate.

16. The composition of claim 11 wherein the free radical initiator is 2,5-dimethyl-2,5-di-(tert-butylperoxy hexane).

17. The composition of claim 10 or 11 wherein the filler is talc.

18. The composition of claim 1 as a blown film.

19. A composite composition which comprises:
(a) a reactively blended polyester polymer covalently bonded to an unsaturated compound as a result of having been blended; and
(b) an organic filler having hard surface groups which react with the polymer of (a) which reacted with the coupled unsaturated compound, the filler being present in an amount between about 15 and 40% by weight of the composition.
